(19) United States
(12) Patent Application Publication
(10) Pub. No.: US 2015/0010464 A1
(43) Pub. Date: Jan. 8, 2015

(54) METHOD FOR PRODUCING METAL OXIDE FILM AND METAL OXIDE FILM

(71) Applicants: Takahiro Shirahata, Tokyo (JP); Hiroyuki Orita, Tokyo (JP); Takahiro Hiramatsu, Tokyo (JP)

(72) Inventors: Takahiro Shirahata, Tokyo (JP); Hiroyuki Orita, Tokyo (JP); Takahiro Hiramatsu, Tokyo (JP)

(73) Assignee: TOSHIBA MITSUBISHI-ELECTRIC INDUSTRIAL SYSTEMS CORPORATION, Tokyo (JP)

(21) Appl. No.: 14/368,954

(22) PCT Filed: Oct. 24, 2012
(86) PCT No.: PCT/JP12/77416

§ 371 Date: Jun. 26, 2014

(30) Foreign Application Priority Data
Feb. 8, 2012 (JP) PCT/JP12/52835

(51) Int. Cl. H01B 13/00; H01B 1/08; C01G 9/02

(52) U.S. Cl. CPC H01B 13/003; H01B 13/0016; C01G 9/02; H01B 1/08
USPC 423/622; 427/9

(57) ABSTRACT

The present invention includes the steps of (A) forming a solution containing zinc into mist and spraying the solution formed into mist onto a substrate under no vacuum to form a metal oxide film on the substrate, and (B) irradiating the metal oxide film with ultraviolet rays to decrease a resistance of the metal oxide film. Further, the step (B) includes the steps of (B-1) determining, in accordance with a film thickness of the metal oxide film, wavelengths of the ultraviolet rays to be radiated, and (B-2) irradiating the metal oxide film with the ultraviolet rays having the wavelengths determined in said step (B-1).

### TECHNICAL FIELD

The present invention relates to a method for producing a metal oxide film and a metal oxide film, and is applicable to a method for producing a metal oxide film for use in, for example, solar cells and electronic devices.

### BACKGROUND ART

Techniques such as metal organic chemical vapor deposition (MOCVD) and sputtering that use a vacuum are employed as the method for forming a metal oxide film used in, for example, solar cells and electronic devices. The metal oxide films produced by those methods for manufacturing a metal oxide film have excellent film properties.

For example, a transparent conductive film, which has been produced by the method for producing a metal oxide film, has a low resistance. If the produced transparent conductive film is heated, its resistance does not increase.

Patent Literature 1 is an example of the prior literatures regarding the formation of a zinc oxide film by the MOCVD technique. Patent Literature 2 is an example of the prior literatures regarding the formation of a zinc oxide film by the sputtering technique.

### CITATION LIST

### Patent Literatures

Patent Literature 1: Japanese Patent Application Laid-Open No. 2011-124330

Patent Literature 2: Japanese Patent Application Laid-Open No. 09-45140 (1997)

### SUMMARY OF INVENTION

### Problems to be Solved by the Invention

Unfortunately, the MODVD technique requires a high cost in addition to requiring the use of materials that are unstable in the air, which makes it inferior from the standpoint of convenience.

In the thin film formation where impurities are intentionally doped into a film by sputtering, a principal material containing a dopant material at a predetermined concentration is generally used as a target. This results in that the dopant concentrations in the films formed of the same target are limited to the dopant concentration of the target. For example, accordingly, the formation of thin films having different dopant concentrations requires targets each corresponding to their concentrations, causing difficulty in deriving film formation conditions. A plurality of apparatuses are required in producing a laminated structure having varying doping concentrations by sputtering, which unfortunately increases an apparatus cost.

The present invention has therefore has an object to provide a method for producing a metal oxide film, by which a metal oxide film having excellent film properties (low resistance) can be produced at low cost. The present invention has another object to provide a method for producing a metal oxide film, by which the resistance of a metal oxide film can be decreased more efficiently. The present invention has still another object to provide a metal oxide film formed by the method for producing a metal oxide film.

### Means for Solving the Problems

To achieve the above-mentioned objects, according to the present invention, a method for producing a metal oxide film includes the steps of (A) forming a solution containing zinc into mist and spraying the solution formed into mist onto a substrate under no vacuum to form a metal oxide film on the substrate, and (B) irradiating the metal oxide film with ultraviolet rays to decrease a resistance of the metal oxide film, the step (B) including the steps of (B-1) determining, in accordance with a film thickness of the metal oxide film, wavelengths of the ultraviolet rays to be radiated, and (B-2) irradiating the metal oxide film with the ultraviolet rays having the wavelengths determined in the step (B-1).

### Effects of the Invention

According to claim 1 of the present invention, the method for producing a metal oxide film includes the steps of (A) forming a solution containing zinc into mist and spraying the solution formed into mist onto a substrate under no vacuum to form a metal oxide film on the substrate, and (B) irradiating the metal oxide film with ultraviolet rays to decrease a resistance of the metal oxide film, the step (B) including the steps of (B-1) determining, in accordance with a film thickness of the metal oxide film, wavelengths of the ultraviolet rays to be radiated, and (B-2) irradiating the metal oxide film with the ultraviolet rays having the wavelengths determined in the step (B-1).

If a metal oxide film is formed on a substrate under no vacuum and the resistance of the formed metal oxide film increases, therefore, the resistance of the metal oxide film can be decreased through ultraviolet ray irradiation to be performed thereafter (the resistance of the metal oxide film formed under no vacuum can be decreased to be nearly identical to the resistance of the metal oxide film formed under no vacuum). The present invention does not require, for example, an apparatus for forming and maintaining a vacuum state as a film forming apparatus. This allows for a lower cost as well as improved convenience.

The present invention determines the wavelengths of ultraviolet rays to be radiated, in accordance with the film thickness of a metal oxide film. Thus, in accordance with the film thickness of a metal oxide film, the metal oxide film can be irradiated with ultraviolet rays having wavelengths enough to improve the efficiency of decreasing a resistance (decreasing a resistivity in a short period of time).

The object, features, aspects and advantages of the present invention will become more apparent from the following detailed description and the attached drawings.

### BRIEF DESCRIPTION OF THE DRAWINGS

FIG. 1 A configuration diagram of a film forming apparatus for describing a method for forming a metal oxide film according to the present invention.

FIG. 2 A diagram for describing a method for producing a metal oxide film (in particular, a method for decreasing a resistance) according to the present invention.

FIG. 3 A diagram showing experimental data for describing the effects of the method for producing a metal oxide film according to the present invention.

FIG. 4 Another diagram showing experimental data for describing the effects of the method for producing a metal oxide film according to the present invention.

FIG. 5 A table showing experimental data for describing the effects of the method for producing a metal oxide film according to the present invention.

FIG. 6 A diagram showing experimental data for describing the effects of the method for producing a metal oxide film according to the present invention.

FIG. 7 Another diagram showing experimental data for describing the effects of the method for producing a metal oxide film according to the present invention.

### DESCRIPTION OF EMBODIMENT

The present invention will be specifically described below with reference to the drawings showing an embodiment.

### Embodiment

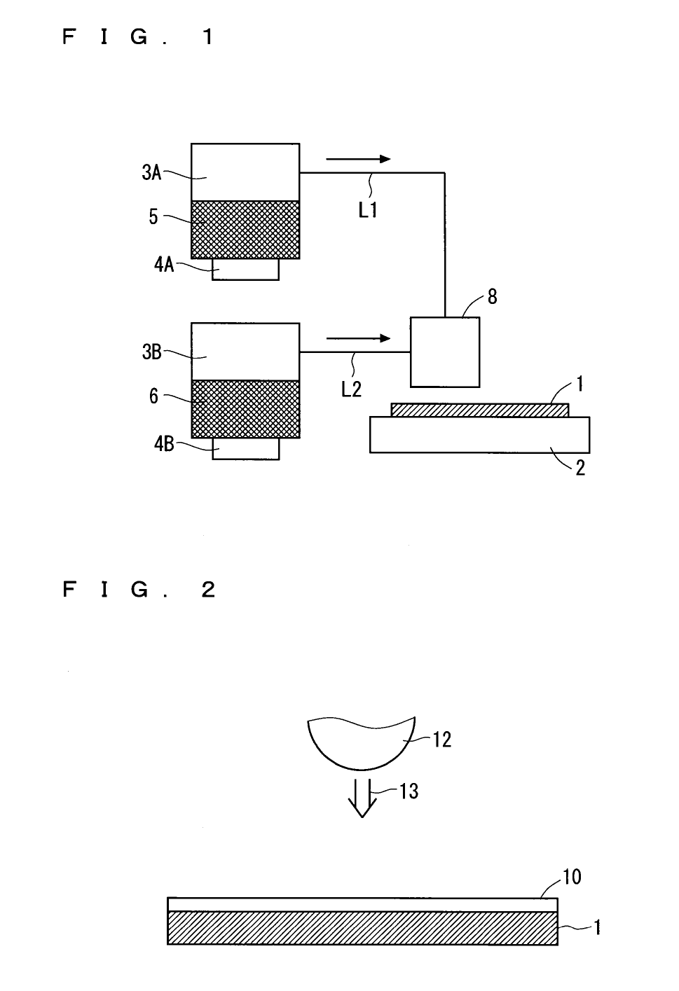

A method for producing a metal oxide film according to the present invention performs the process of forming a film under no vacuum (at atmospheric pressure). The method for producing a metal oxide film according to the present invention will be specifically described using a production apparatus (film forming apparatus) shown in FIG. 1.

First, a solution 5 containing at least zinc is produced. Here, an organic solvent such as ether or alcohol is used as a solvent of the solution 5. The produced solution 5 is filled into a container 3A.

Water (H₂O) is used as an oxidation source 6, and the oxidation source 6 is filled into a container 3B. While oxygen, ozone, hydrogen peroxide, N₂O, NO₂, and the like can be used as the oxidation source 6 in addition to water, water is desirably used in terms of inexpensive cost and easy handling (the oxidation source 6 is water in the following description). In forming a metal oxide film containing a dopant, for example, a dopant is added to water being the oxidation source 6 or is added to the solution 5 containing zinc, depending on the solubility and reactivity of the dopant. Alternatively, another container (not shown in FIG. 1) may be provided to supply the substrate 1 with a dopant.

Next, the solution 5 and oxidation source 6 are individually formed into mist. The container 3A is provided with an atomizer 4A on the bottom thereof, whereas the container 3B is provided with an atomizer 4B on the bottom thereof. The atomizer 4A forms the solution 5 in the container 3A into mist, whereas the atomizer 4B forms the oxidation source 6 in the container 3B into mist.

The solution 5 formed into mist passes through a path L1 to be supplied to a nozzle 8, whereas the oxidation source 6 formed into mist passes through a path L2 to be supplied to the nozzle 8. As shown in FIG. 1, here, the path L1 and path L2 are different paths.

As shown in FIG. 1, a substrate 1 is placed on a heating unit 2. Here, the substrate 1 is placed under no vacuum (at atmospheric pressure). The solution 5 formed into mist and the oxidation source 6 formed into mist are sprayed onto the substrate 1 placed under no vacuum (at atmospheric pressure) by means of the nozzle 8. In this spraying, the substrate 1 is heated to, for example, about 200° C. on the heating unit 2.

Through the step above, a metal oxide film (zinc oxide film being a transparent conductive film) having a predetermined film thickness is formed on the substrate 1 placed under no vacuum (at atmospheric pressure). Adjusting a supply amount of the solution 5 or the like allows for adjustment of the film thickness of the metal oxide film to a desired thickness.

The metal oxide film formed under no vacuum (at atmospheric pressure) has a resistance higher than that of a metal oxide film formed under vacuum by, for example, sputtering. The method for producing a metal oxide film according to the present invention thus performs the following treatments.

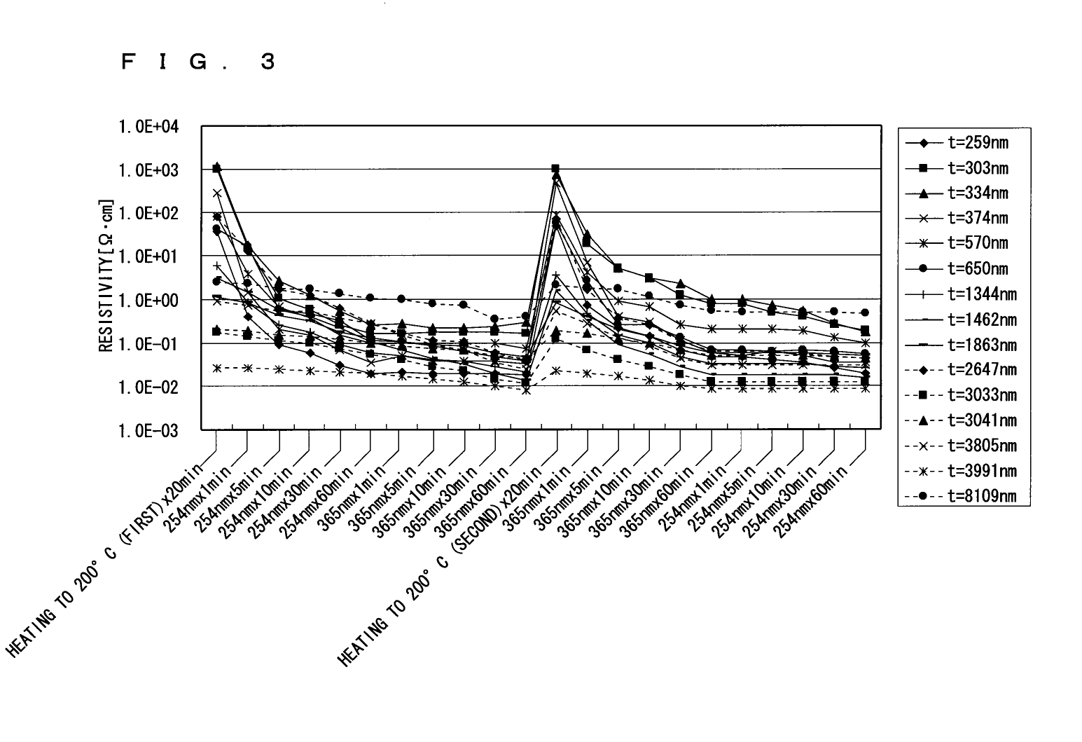

In the method for producing a metal oxide film according to the present invention, as shown in FIG. 2, the entire main surface of a metal oxide film 10 formed on the substrate 1 is irradiated with ultraviolet rays 13 using, for example, an ultraviolet lamp 12. The irradiation with the ultraviolet rays 13 decreases the resistance (resistivity) of the metal oxide film 10.

In the method for producing a metal oxide film according to the present invention, further, the wavelengths of the ultraviolet rays 13 to be radiated are determined in the ultraviolet ray irradiation treatment, in accordance with the film thickness of the metal oxide film 10. The entire main surface of the metal oxide film 10 is then irradiated with the ultraviolet rays 13 having the determined wavelengths.

The method for determining the wavelengths of the ultraviolet rays 13 to be radiated will be described in detail using the following experimental example.

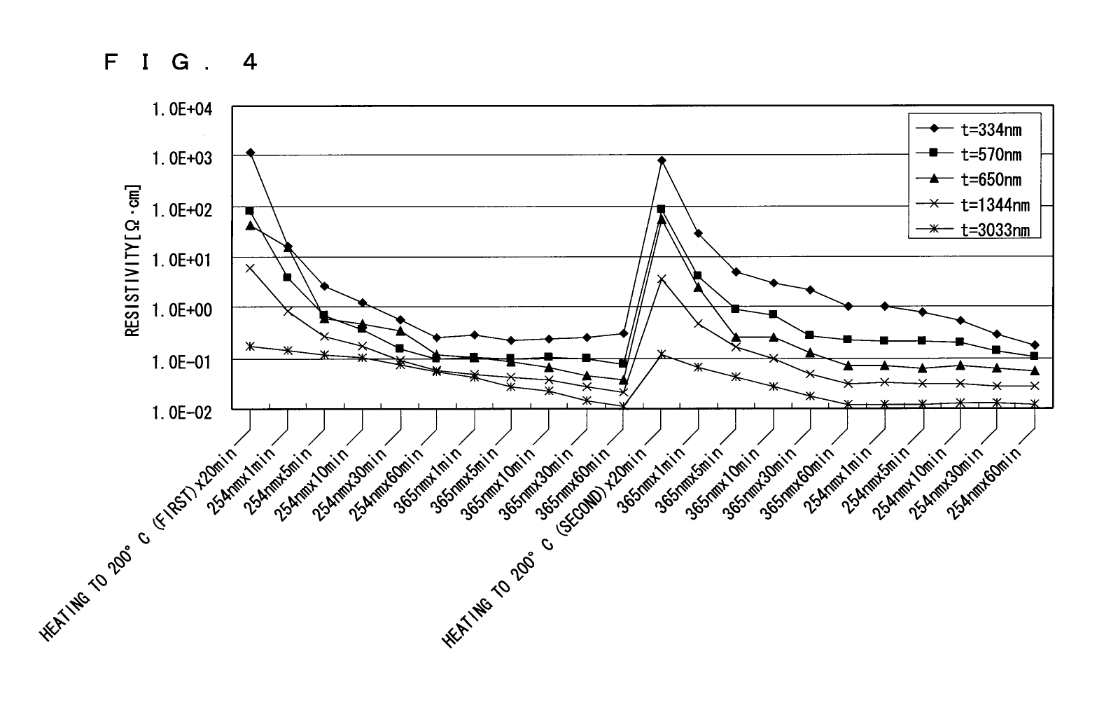

FIGS. 3 and 4 show experimental data of the relationship between the resistivity of the metal oxide film and irradiation with ultraviolet rays for each of the film thicknesses of metal oxide films (zinc oxide films). FIG. 4 shows the data regarding film thicknesses of the metal oxide films having arbitrary film thicknesses, which are selected from the experimental data shown in FIG. 3.

As indicated by the horizontal axes of FIGS. 3 and 4, the metal oxide film formed under no vacuum was subjected to a first heat treatment for 20 minutes, and the metal oxide film after the first heat treatment was irradiated with ultraviolet rays having a center wavelength of 254 nm for 60 minutes. Then, the metal oxide film was irradiated with ultraviolet rays having a center wavelength of 365 nm for 60 minutes, and the metal oxide film was subjected to a second heat treatment for 20 minutes. After that, the metal oxide film after the second heat treatment was irradiated with ultraviolet rays having a center wavelength of 365 nm for 60 minutes, and then, the metal oxide film was irradiated with ultraviolet rays having a center wavelength of 254 nm for 60 minutes.

As shown in FIGS. 3 and 4, the vertical axes indicate the resistivity (Ω·cm) of the metal oxide film. FIG. 3 shows the data regarding the metal oxide films having film thicknesses of 259 nm, 303 nm, 334 nm, 374 nm, 570 nm, 650 nm, 1344 nm, 1462 nm, 1863 nm, 2647 nm, 3033 nm, 3041 nm, 3805 nm, 3991 nm, and 8109 nm. FIG. 4 shows the data regarding the metal oxide films having film thicknesses of 334 nm, 570 nm, 650 nm, 1344 nm, and 3033 nm.

The first and second heat treatments perform heating at such a temperature (for example, 300° C. or lower) as not to cause a change in crystallinity (as an example, an oxygen vacancy of ZnO is filled) of the metal oxide film, and the metal oxide film was heated to 200° C. in the first and second heat treatments shown in FIGS. 3 and 4.

The metal oxide film (zinc oxide film (ZnO)) formed in the experiment was produced (formed) through the above-mentioned step with the apparatus shown in FIG. 1. The temperature for heating the substrate 1 during film formation is 200° C., a supply amount of the solution 5 containing zinc (Zn) is 0.7 to 0.8 mmol/minute, and a supply amount of water being the oxidation source 6 is 44 to 89 mmol/minute. The zinc concentration in the solution 5 containing zinc is 0.35 mol/liter.

The metal oxide film formed under no vacuum has a resistivity higher than that of a metal oxide film formed under vacuum. It was found that as shown in the experimental data of FIGS. 3 and 4, irradiation of the metal oxide film, which has been formed under no vacuum, with ultraviolet rays decreases the resistivity of the metal oxide film.

FIGS. 3 and 4 also show that the heat treatment increases the resistivity of the metal oxide film, which has been previously decreased. FIGS. 3 and 4 further show that irradiation with ultraviolet rays again can decrease the resistivity that has been increased through the heat treatment.

It is effective from the viewpoint of decreasing the resistance of a metal oxide film to irradiate the metal oxide film having a high resistance, which has been formed under no vacuum, with ultraviolet rays and, if the resistance of the metal oxide film has increased through a heating step, irradiate the metal oxide film subjected to the heating step with ultraviolet rays. Even if the heating step (heat treatment) and the ultraviolet ray irradiation treatment are repeated on the metal oxide film, the resistance that has been increased through the heat treatment can be decreased after the ultraviolet ray irradiation treatment.

In FIGS. 3 and 4, attention is paid to the slope showing a reduction in the resistivity of the metal oxide film when the metal oxide film was irradiated with ultraviolet rays (referred to as first ultraviolet rays) having a center wavelength of 254 nm after the first heat treatment and the slope showing a reduction in the resistivity of the metal oxide film when the metal oxide film was irradiated with ultraviolet rays (referred to as second ultraviolet rays) having a center wavelength of 365 nm after the second heat treatment.

The resistivity of the metal oxide film having a relatively small film thickness can be reduced by a larger amount in a short period of time through irradiation with the first ultraviolet rays than through irradiation with the second ultraviolet rays. Meanwhile, the resistivity of the metal oxide film having a relatively large film thickness can be reduced by a larger amount in a short period of time through irradiation with the second ultraviolet rays than through irradiation with the first ultraviolet rays.

From the viewpoint of efficiently decreasing resistance, the optimum wavelength of ultraviolet rays to be radiated is efficiently selected and determined depending on the film thickness of the metal oxide film.

To be specific, from the viewpoint of efficiently decreasing resistance, ultraviolet rays having the wavelength of a larger value are desirably selected as the film thickness of the metal oxide film becomes larger. This is based on such a relationship that the depth of ultraviolet rays penetrating a metal oxide film is proportional to the wavelength of the ultraviolet rays.

The penetration depth d of light is expressed by d=1/α, where α represents an absorption coefficient and α=4πk/λ (k: extinction coefficient, λ: wavelength). In other words, the depth of ultraviolet rays penetrating the metal oxide film is proportional to the wavelength of the ultraviolet rays (ultraviolet rays having a larger wavelength can penetrate a metal oxide film up to a deeper position).

Unless ultraviolet rays having a larger wavelength are used, a metal oxide film having a larger film thickness accordingly cannot be irradiated with ultraviolet rays entirely in the film thickness direction of the metal oxide film having a larger film thickness. This results in a reduction in the efficiency of decreasing a resistance of the metal oxide film. From the viewpoint of efficiently decreasing resistance, thus, the wavelength of ultraviolet rays to be determined is desirably increased as the film thickness of a metal oxide film becomes larger.

A metal oxide film (zinc oxide film) does not absorb ultraviolet rays whose wavelength is larger than 380 nm. For the zinc oxide film, thus, the wavelength of ultraviolet rays to be radiated needs to be 380 nm or smaller.

Light sources that emit ultraviolet rays having a wavelength of 254 nm and light sources that emit ultraviolet rays having a wavelength of 365 nm are available at relatively inexpensive cost. In order to decrease resistance more efficiently, it is thus extremely beneficial to determine which of the wavelengths of 254 nm and 365 nm is selected in accordance with the film thickness of the metal oxide film.

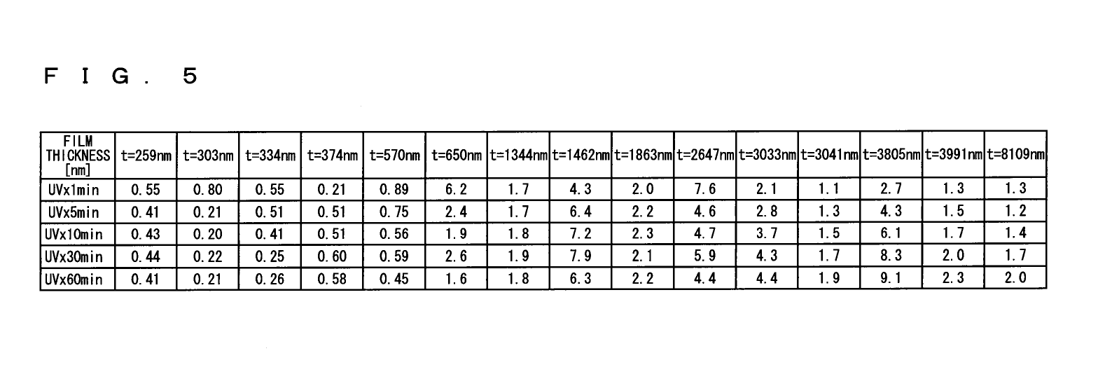

FIG. 5 is a table showing which of the wavelengths of 254 nm and 365 nm is beneficial for ultraviolet rays to be radiated in accordance with the film thickness of the metal oxide film. FIG. 5 is created using the data shown in FIG. 3.

The uppermost fields of FIG. 5 show film thicknesses of metal oxide films (259 nm, 303 nm, 334 nm, 374 nm, 570 nm, 650 nm, 1344 nm, 1462 nm, 1863 nm, 2647 nm, 3033 nm, 3041 nm, 3805 nm, 3991 nm, and 8109 nm). The leftmost fields of FIG. 5 show irradiation times (1 minute, 5 minutes, 10 minutes, 30 minutes, and 60 minutes) with ultraviolet rays.

Each of the values in the fields of FIG. 5 shows (the resistivity of a metal oxide film after irradiation with ultraviolet rays having a center wavelength of 254 nm for an irradiation time)/(the resistivity of a metal oxide film after irradiation with ultraviolet rays having a center wavelength of 365 nm for an irradiation time).

As an example, attention is paid to the third column (column for a film thickness of 303 nm) of FIG. 5. The value on the second row (row for ultraviolet rays irradiation time of one minute) of the third column is a value obtained by dividing the “resistivity of a metal oxide film having a film thickness of 303 nm after being irradiated with ultraviolet rays having a center wavelength of 254 nm for one minute” by the “resistivity of a metal oxide film having a film thickness of 303 nm after being irradiated with ultraviolet rays having a center wavelength of 365 nm for one minute”, which is “0.8”.

As another example, attention is paid to the seventh column (column for a film thickness of 650 nm) of FIG. 5. The value on the fifth row (row for ultraviolet rays irradiation time of 30 minutes) of the seventh column is a value obtained by dividing the “resistivity of a metal oxide film having a film thickness of 650 nm after being irradiated with ultraviolet rays having a center wavelength of 254 nm for 30 minutes” by the “resistivity of a metal oxide film having a film thickness of 650 nm after being irradiated with ultraviolet rays having a center wavelength of 365 nm for 30 minutes”, which is “2.6”.

The (resistivity of a metal oxide film after irradiation with ultraviolet rays having a center wavelength of 254 nm for an irradiation time)/(the resistivity of a metal oxide film after irradiation with ultraviolet rays having a center wavelength of 365 nm for an irradiation time) will be referred to as a “resistivity comparison ratio” below.

The resistivity comparison ratio smaller than “1” indicates that the resistance of the metal oxide film can be decreased more efficiently through irradiation with ultraviolet rays having a center wavelength of 254 nm than through irradiation with ultraviolet rays having a center wavelength of 365 nm. In other words, the resistivity comparison ratio larger than “1” indicates that the resistivity of the metal oxide film can be decreased more efficiently through irradiation with ultraviolet rays having a center wavelength of 365 nm than through irradiation with ultraviolet rays having a center wavelength of 254 nm.

The table of FIG. 5 shows that at least in a case of a metal oxide film having a film thickness of equal to or smaller than 570 nm, the resistance of a metal oxide film can be decreased more efficiently through irradiation with ultraviolet rays having a center wavelength of 254 nm than through irradiation with ultraviolet rays having a center wavelength of 365 nm.

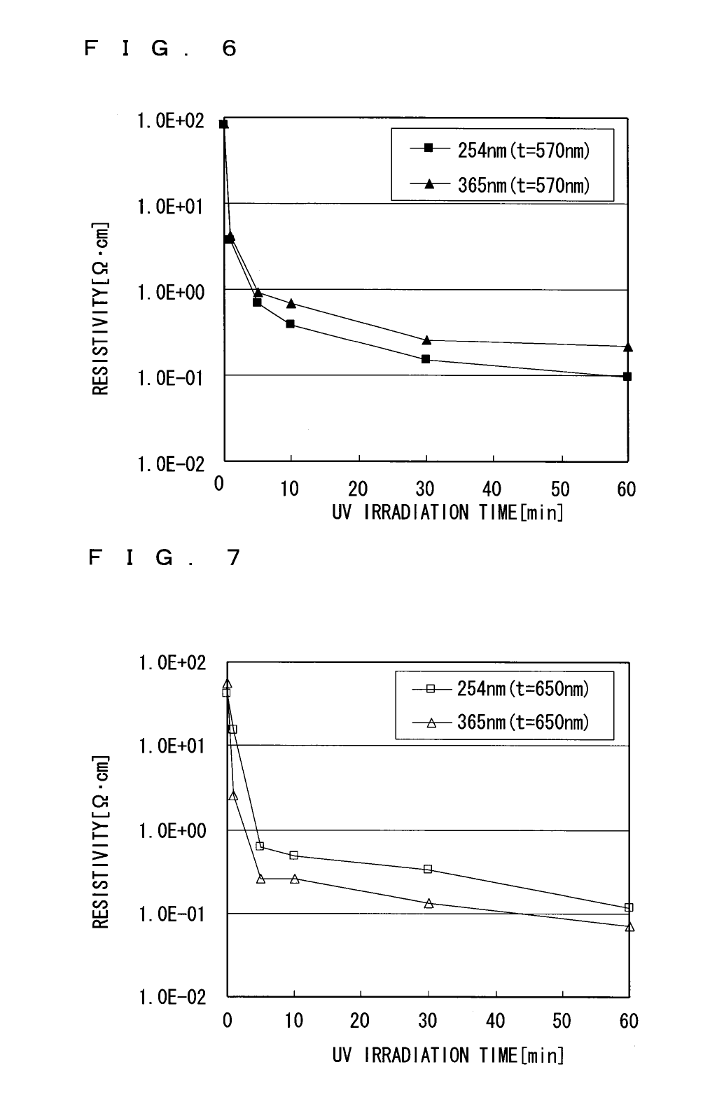

The above is shown more specifically in FIG. 6. FIG. 6 (vertical axis: resistivity (Ω·m), horizontal axis: ultraviolet ray irradiation time (minute)) shows, for a metal oxide film having a film thickness of 570 nm, the irradiation with ultraviolet rays having a center wavelength of 254 nm and changes in resistivity, and the irradiation with ultraviolet rays having a center wavelength of 365 nm and changes in resistivity. As shown in FIG. 6, for the metal oxide film having a film thickness of 570 nm, the resistance of the metal oxide film can be decreased more efficiently through irradiation with ultraviolet rays having a center wavelength of 254 nm than through irradiation with ultraviolet rays having a center wavelength of 365 nm.

The table of FIG. 5 shows that at least in a case of a metal oxide film having a film thickness of equal to or smaller than 650 nm, the resistance of a metal oxide film can be decreased more efficiently through irradiation with ultraviolet rays having a center wavelength of 365 nm than through irradiation with ultraviolet rays having a center wavelength of 254 nm.

The above is more specifically shown in FIG. 7. FIG. 7 (vertical axis: resistivity (Ω·cm), horizontal axis: ultraviolet ray irradiation time (minute)) shows, for a metal oxide film having a film thickness of 650 nm, the irradiation with ultraviolet rays having a center wavelength of 254 nm and changes in resistivity, and the irradiation with ultraviolet rays having a center wavelength of 365 nm and changes in resistivity. As shown in FIG. 7, for the metal oxide film having a film thickness of 650 nm, the resistance of the metal oxide film can be decreased more efficiently through irradiation with ultraviolet rays having a center wavelength of 365 nm than through irradiation with ultraviolet rays having a center wavelength of 254 nm.

By taking advantage of the fact that the resistivity comparison ratio increases linearly between the film thicknesses of 570 nm to 650 nm, an average value was calculated from the data of the sixth column (film thickness=570 nm) of FIG. 5 and the data of the seventh column (film thickness=650 nm) of FIG. 5. Then, it was found that the resistivity comparison ratio is “one” when the metal oxide film has a film thickness of about 590 nm.

For example, by taking advantage of the fact that the resistivity comparison ratio increases linearly between the film thicknesses of 570 nm to 650 nm, the film thickness of a metal oxide film that meets a resistivity comparison ratio of “1” is “572 nm” when the ultraviolet ray irradiation is performed for one minute, the film thickness of a metal oxide film that meets a resistivity comparison ratio of “1” is “583 nm” when the ultraviolet ray irradiation is performed for five minutes, the film thickness of a metal oxide film that meets a resistivity comparison ratio of “1” is “596 nm” when the ultraviolet ray irradiation is performed for 10 minutes, the film thickness of a metal oxide film that meets a resistivity comparison ratio of “1” is “586 nm” when the ultraviolet ray irradiation is performed for 30 minutes, and the film thickness of a metal oxide film that meets a resistivity comparison ratio of “1” is “607 nm” when the ultraviolet ray irradiation is performed for 60 minutes. Averaging of those film thickness values shows that the resistivity comparison ratio is “one” when the metal oxide film has a film thickness of about 590 nm.

The inventors have found that for a metal oxide film having a film thickness smaller than 590 nm, the resistance of the metal oxide film can be decreased more efficiently through irradiation with ultraviolet rays having a center wavelength of 254 nm than through irradiation with ultraviolet rays having a center wavelength of 365 nm.

The inventors have further found that for a metal oxide film having a film thickness larger than 590 nm, the resistance of the metal oxide film can be decreased more efficiently through irradiation with ultraviolet rays having a center wavelength of 365 nm than through irradiation with ultraviolet rays having a center wavelength of 254 nm.

It is conceivable that for a metal oxide film having a film thickness of 590 nm, the resistance of the metal oxide film can be decreased with similar efficiency when the metal oxide film is irradiated with ultraviolet rays having a center wavelength of 254 nm and when the metal oxide film is irradiated with ultraviolet rays having a center wavelength of 365 nm.

In determining ultraviolet rays, with which a metal oxide film is irradiated, thus, for reducing a cost of ultraviolet ray irradiation and improving resistance reduction efficiency, wavelengths including at least 254 nm are desirably selected for a metal oxide film having a film thickness smaller than 590 nm, and the wavelengths including at least 365 nm are desirably selected for a metal oxide film having a film thickness larger than 590 nm.

The above description (the resistance of a metal oxide film can be decreased by irradiating the metal oxide film after film formation and the metal oxide film after heat treatment with ultraviolet rays and, from the viewpoint of efficiently decreasing a resistance, the wavelength of ultraviolet rays to be radiated is selected and determined in accordance with the film thickness of the metal oxide film) has been confirmed for both of the case in which a metal oxide film contains a dopant and the case in which a metal oxide film contains no dopant. It has also been confirmed that the above description holds true for a case in which a metal oxide film contains a dopant, irrespective of the types of dopants such as boron and indium.

In the method for producing a metal oxide film according to this embodiment, as described above, the solution 5 containing zinc is formed into mist, and the solution 5 formed into mist is sprayed onto the substrate 1 under no vacuum, to thereby form the metal oxide film 10 on the substrate 1 (FIG. 1). Then, the metal oxide film 10 is irradiated with the ultraviolet rays 13 (FIG. 2).

Thus, if the resistance of the metal oxide film, which has been formed on the substrate 1 under no vacuum, becomes higher, ultraviolet ray irradiation to be performed thereafter can decrease the resistance of the metal oxide film (the resistance of a metal oxide film formed under no vacuum can be reduced so as to be nearly identical to the resistance of a metal oxide film formed under vacuum).

The method for producing a metal oxide film according to this embodiment does not require a vacuum-system apparatus or other apparatus as a production (film forming) apparatus (that is, a film formation process is performed under no vacuum). This allows for lower cost as well as improved convenience.

The method for producing a metal oxide film according to this embodiment determines the wavelength of ultraviolet rays to be radiated, in accordance with the film thickness of a metal oxide film. For example, a wavelength having a larger value is selected as the wavelength of ultraviolet rays as the film thickness of the metal oxide film becomes larger.

For this reason, in accordance with the film thickness of a metal oxide film, the metal oxide film thus can be irradiated with ultraviolet rays having such a wavelength as to increase the efficiency of decreasing resistance (further reduce the resistivity in a short period of time).

In the method for producing a metal oxide film according to this embodiment, wavelengths including at least 254 nm may be selected and detected for a metal oxide film having a film thickness smaller than 590 nm, and wavelengths including at least 365 nm may be selected and detected for a metal oxide film having a film thickness larger than 590 nm.

The ultraviolet light sources having a wavelength of 254 nm and the ultraviolet light sources having a wavelength of 365 nm are inexpensive. Such ultraviolet rays as to efficiently reduce resistance are selected in accordance with the film thickness of a metal oxide film. The method for producing a metal oxide film according to the present invention, in which wavelengths are selected and detected as described above, can thus increase the efficiency of decreasing the resistance of a metal oxide film and can reduce a production cost thereof.

In the method for producing a metal oxide film according to this embodiment, a metal oxide film after film formation may be irradiated with ultraviolet rays, to thereby decrease the resistance of the metal oxide film. Alternatively, a metal oxide film after film formation may be subjected to heat treatment, and then, the metal oxide film whose resistance has been increased may be irradiated with ultraviolet rays, to thereby decrease the resistance of the metal oxide film whose resistance has been increased.

If a metal oxide film needs heat treatment several times, the ultraviolet ray irradiation treatment may be performed every time heat treatment has been performed, or heat treatment may be performed several times and the ultraviolet ray treatment may be performed once after the last heat treatment. The wavelength in ultraviolet ray irradiation is desirably selected and determined from the viewpoint of efficiently decreasing resistance.

After the formation of a metal oxide film, the metal oxide film may be desired to be subjected to heat treatment at least one or more times in production steps. Also in such a case, the resistance of a metal oxide film whose resistance has been increased can be decreased through ultraviolet ray irradiation after the heat treatment. The wavelengths in ultraviolet ray irradiation are selected and determined to predetermined values, and a metal oxide film whose resistance has been increased is irradiated with ultraviolet rays having the selected determined wavelengths, so that the resistance of the metal oxide film can be decreased efficiently.

The present invention has been described in detail, but the above-mentioned description is illustrative in all aspects and the present invention is not intended to be limited thereto. Various modifications not exemplified are construed to be made without departing from the scope of the present invention.

### DESCRIPTION OF REFERENCE SIGNS

1 substrate
2 heating unit
3A, 3B container
4A, 4B atomizer
5 solution
6 oxidation source
8 nozzle
10 metal oxide film (transparent conductive film, zinc oxide film)
12 ultraviolet lamp
13 ultraviolet rays
L1, L2 path

1. A method for producing metal oxide film, the method comprising:
(A) spraying a mist of a solution comprising zinc onto a substrate at atmospheric pressure to form a metal oxide film on said substrate; and
(B) irradiating said metal oxide film with ultraviolet rays,
wherein (B) comprises:
(B-1) determining, in accordance with the film thickness of said metal oxide film, the wavelength of said ultraviolet rays to be radiated; and
(B-2) irradiating said metal oxide film with said ultraviolet rays at the wavelength determined in (B-1).

2. The method for producing metal oxide film according to claim 1, wherein (B-1) selects the wavelength with a larger value as the wavelength for irradiation in B-2 as said metal oxide film thickness increases.

3. The method for producing metal oxide film according to claim 1, wherein when the thickness of said metal oxide film is less than 590 nm the wavelength for irradiation is at least 254 nm.

4. The method for producing metal oxide film according to claim 1, wherein when the thickness of said metal oxide film is greater than 590 nm the wavelength for irradiation is at least 365 nm.

5. The method for producing metal oxide film according to claim 1, further comprising
(C) heating said metal oxide film,
wherein (B) is performed after (C).

6. A metal oxide film, produced by the method of claim 1.

7. A metal oxide film, produced by the method of claim 5.

8. The method for producing a metal oxide film according to claim 1, wherein when the thickness of said metal oxide film is equal to 590 nm, the wavelength for irradiation is at least 254 nm and/or at least 365 nm.
